(19) United States
(12) Patent Application Publication
(10) Pub. No.: US 2002/0054231 A1
(43) Pub. Date: May 9, 2002

(54) Exposure method, exposure apparatus, and process of production of device

(75) Inventor: Takashi Masuyuki, Frankfurt (DE)

Correspondence Address: OLIFF & BERRIDGE, PLC, P.O. BOX 19928, ALEXANDRIA, VA, 22320, US

(73) Assignee: NIKON CORPORATION, Chiyoda-ku (JP)

(21) Appl. No.: 09/865,606

(22) Filed: May 29, 2001

(30) Foreign Application Priority Data
May 31, 2000 (JP) 2000-161427

(51) Int. Cl. H04N 5/235

(52) U.S. Cl. 348/362

(57) ABSTRACT

An exposure method for exposing the same location of the substrate a plurality of times through a mask formed with a pattern while changing the amounts of exposure with respect to a substrate by pulse light at a plurality of positions in the direction (Z-direction) in which the substrate being exposed is irradiated by the pulse light, wherein the energy of the pulse light is set so that the cumulative number of pulses at the position giving the maximum amount of exposure in the plurality of positions becomes at least the predetermined number of pulses.

### BACKGROUND OF THE INVENTION

1. Field of the Invention

The present invention relates to an exposure method and exposure apparatus used in a lithography process for producing a thin film magnetic head, a semiconductor device, a liquid crystal display, an image pickup device (CCD etc.), or another microdevice or a mask (including a reticle) etc. and a process for production of a device using the same.

2. Description of the Related Art

When producing a thin film magnetic head, a semiconductor device, a liquid crystal display, or another microdevice, use is made of an exposure apparatus for exposure and transfer of a pattern of a reticle used as a mask through a projection optical system to a plurality of shot areas on a semiconductor wafer or glass plate coated with a photoresist or another photosensitive substrate.

In such an exposure apparatus, before the exposure, the position on the photosensitive substrate in the direction along the optical axis of the projection optical system (Z-direction) is detected and focusing performed to move the photosensitive substrate in the Z-direction so as to match with the best focus of the projection optical system.

The position of the photosensitive substrate in the Z-direction is for example detected by an oblique incidence type focus detection device which emits a detection beam of a wavelength different from the wavelength of the exposure light obliquely on the photosensitive substrate and photoelectrically detects the reflected light. The detection beam forms a spot image or slit image on the part of the surface of the photosensitive substrate positioned at the substantive center in the projection field of the projection optical system. Therefore, the amount of positional deviation of the photosensitive substrate in the optical axis direction, that is, the amount of defocus, is measured based on the photoelectric detection signal with reference to the receiving position of the reflected light photoelectrically detected when the surface of the photosensitive substrate is in register with the best focus plane of the projection optical system. Further, a Z-stage is controlled in drive to move the photosensitive substrate in the Z-direction for focusing so that the amount of focal deviation detected becomes zero.

This focusing (detection of Z-direction and drive of Z-stage) is generally performed in the state with the shot to be exposed (exposure position) set at the projection field (projection position) of the projection optical system, so when the detection position of the focus is set at the center of the projection field, it is performed at the center of the shot. The focusing however is sometimes performed at a shift position shifted from the exposure position (position away from center of the shot) deliberately or due to some sort of situation. Below, the processing for focusing at this shift position will be called “shift focusing”. In this shift focusing, the measurement point (focusing position of detection beam) ends up being positioned at the edge of the wafer in the state where the wafer is arranged at the exposure position. Sometimes the height cannot be measured accurately or sometimes there is no measurement point in a predetermined step area in a shot having a step when positioning in the height direction (Z-direction) with respect to the imaging plane of the projection optical system using as a reference the predetermined step area.

As a technique for accurately forming a pattern having a large aspect ratio (for example a contact hole pattern having a large depth (resist thickness) with respect to the pattern width), there is known the exposure method of emitting exposure light while continuously moving the photosensitive substrate in a direction along the optical axis of the projection optical system (Z-direction). Below, this exposure method will be called “continuous cumulative focusing”. Further, an exposure method has been proposed which emits exposure light at different positions with different amounts of exposure while positioning the photosensitive substrate in steps at several positions in the Z-direction. Below, this exposure method will be called “step-wise cumulative focusing”. By moving the photosensitive substrate in the Z-direction in this way, it is possible to accurately form a pattern with a large aspect ratio.

Further, recently, from the viewpoint of shortening the wavelength of the exposure light or controlling the exposure light along with the demands for improvement of the exposure accuracy, a KrF excimer laser (wavelength 248 nm) or ArF excimer laser (wavelength 193 nm) or other light source which emits pulse light is used. When using such a pulse laser light source as the exposure light source, since there is variation in the energy for each pulse in pulse light, it is attempted to obtain the desired reproducibility of accuracy of control of the amount of exposure by exposure by at least a certain number of light pulses (hereinafter referred to as the “minimum number of exposure pulses”). In this case, when for example exposing a high sensitivity resist, since the set amount of exposure is small, if using the laser light from the pulse laser light source as it is, sometimes exposure by more than the minimum number of exposure pulses is not possible. Therefore, when the set amount of exposure is small in this way, for example, it is possible to perform exposure by a number of pulses more than the minimum number of exposure pulses by reducing the energy of the pulse light by a light attenuating means set in the optical path.

When using a pulse laser light source for the above cumulative focusing, the light attenuating means has been controlled so that the number of pulses becomes more than the minimum number of exposure pulses as a whole for each shot regardless of the Z-position.

Further, in the above shift focusing and in the above cumulative focusing, the following processing has been performed. That is, the photosensitive substrate is moved in the plane (XY plane) orthogonal to the Z-direction to set the photosensitive substrate so that the shift position is in register with the detection position of focus (usually equal to the projection position) and the photosensitive substrate is moved in the XY plane for focusing so that the image formed by the detection beam is in register with a reference position of the focus detection device. Next, the photosensitive substrate is moved in the XY plane to set the photosensitive substrate so that the exposure position is in register with the projection position and exposure performed while moving the photosensitive substrate continuously or in steps in the Z-direction based on the detection value of the focus detection device.

When using a pulse laser light source as the exposure light source and performing step-wise cumulative focusing for focusing at different positions while moving the photosensitive substrate in steps in the Z-direction, in the past a single shot area was exposed several times to achieve at least the minimum number of exposure pulses as a whole. Since more than the minimum number of exposure pulses was not necessarily achieved in the exposure, it was sometimes not possible to obtain a sufficient reproducibility of the accuracy of control of the amount of exposure.

Further, if shift focusing is employed and there is a step between the exposure position and shift position, since the focus detection device has a predetermined effective detection range (for example, a predetermined range above and below a reference position), at the exposure position, the image formed by the detection beam is projected at a position shifted above or below the reference position by exactly an amount corresponding to the step. If the position of the photosensitive substrate in the Z-direction is moved using such a shifted position as the reference for control, the image formed by the detection beam sometimes ends up outside the effective detection range. Sometimes error occurs in the detection or detection becomes impossible.

### SUMMARY OF THE INVENTION

An object of the present invention is to realize sufficient reproducibility of accuracy of control of the amount of exposure in step-wise cumulative focusing using pulse light as exposure light.

Another object of the present invention is to prevent error from occurring in the detection of focus or detection from becoming impossible when employing shift focusing and the above cumulative focusing.

According to a first aspect of the present invention, there is provided an exposure method for exposing an identical location of a substrate being exposed a plurality of times through a mask formed with a pattern while giving different amounts of exposure to the substrate by pulse light at a plurality of positions in the direction in which the substrate is irradiated by the pulse light, comprising a step of setting an energy of the pulse light so that the cumulative number of pulses of the pulse light at the position giving the maximum amount of exposure among the plurality of positions becomes at least a predetermined number of pulses.

According to a second aspect of the present invention, there is provided an exposure apparatus comprising an adjustment device which adjusts an energy of pulse light irradiating a mask formed with a pattern, a projection optical system which projects an image of the pattern of the mask on a substrate, a stage which moves the substrate in an optical axis direction along the optical axis of the projection optical system, and a control device which controls for exposing an identical location of said substrate a plurality of times while moving the stage in steps in said optical axis direction and changing the amount of exposure by the pulse light in accordance with the position of the stage, and controls the adjusting device so that a cumulative number of pulses of said pulse light at the position giving the maximum amount of exposure among the plurality of positions of the stage becomes at least a predetermined number.

According to the exposure method according to the first aspect of the present invention and the exposure apparatus according to the second aspect of the present invention, at the position giving the maximum amount of exposure among the plurality of positions in the optical axis direction, the effect on the exposure accuracy is the largest, so by setting the cumulative number of pulses of the pulse light at that position to at least the minimum number of exposure pulses, the deterioration of the reproducibility of accuracy of control of the amount of exposure accompanying variations in the energy of the pulses of the pulse light is suppressed. Therefore, it becomes possible to form a pattern with a high accuracy.

According to a third aspect of the present invention, there is provided an exposure method comprising a first movement step of moving a substrate being exposed so that its position in an optical axis direction along a projection optical axis becomes in register with a reference position based on a detection value detected by a focus detection device having an effective detection area of a predetermined range in said optical axis direction at a shift position shifted in a plane orthogonal to the projection optical axis from an exposure position to be exposed through a mask formed with a pattern on said substrate, a second movement step of moving said substrate in said plane orthogonal to the optical axis so that the exposure position becomes in register with a projection position of an image of a pattern of the mask, a changing step of changing said reference position so that the reference position becomes in register with the position of the substrate in the optical axis direction based on the detection value detected by the focus detection device at the exposure position, and an exposure step of exposing the same location of the substrate through the mask while moving the substrate in the optical axis direction in accordance with the detection value of the focus detection device.

According to a fourth aspect of the present invention, there is provided an exposure apparatus comprising a projection optical system which projects an image of a pattern of a mask irradiated by exposure light on a substrate, a stage which moves said substrate in an optical axis direction along an optical axis of said projection optical system and in a plane orthogonal to the optical axis substantially orthogonal to the optical axis direction, a focus detection device having an effective detection area of a predetermined range in said optical axis direction and detecting a position of said substrate in said optical axis direction at a projection position of said projection optical system, and a control device which controls the stage to move the substrate so that its position in the optical axis direction becomes in register with a reference position based on a detection value detected by said focus detection device in a state setting a shift position shifted in said plane orthogonal to the optical axis from the exposure position to be exposed through said mask on said substrate at said projection position, changes the reference position so that the reference position becomes in register with the position of the substrate in the optical axis direction based on the detection value detected by the focus detection device in the state setting the exposure position to the projection position, and exposes the same location of the substrate through the mask while moving the substrate in the optical axis direction in accordance with the detection value of the focus detection device.

According to the exposure method according to the third aspect of the present invention and the exposure apparatus according to the fourth aspect of the present invention, since the substrate is moved to the shift position for the focusing, then the reference position of the focus detection device is changed to become in register with the optical axis direction of the substrate at the exposure position and cumulative focusing performed for exposure while moving the substrate in the optical axis direction, even if there is a step between the shift position and the exposure position, the effective detection range of the focus detection device no longer ends up being left at the exposure position and error is prevented from occurring in the detection of the focus and detection from becoming impossible.

### BRIEF DESCRIPTION OF THE DRAWINGS

These and other objects and features of the present invention will become clearer from the following description of the preferred embodiments given with reference to the attached drawings, in which:

FIG. 1 is a view of the overall configuration of an exposure apparatus according to an embodiment of the present invention;

FIG. 2 is a view of the detailed configuration of a focus detection system of an exposure apparatus according to an embodiment of the present invention;

FIG. 3 is a view of the configuration of a light source and the configuration of an energy adjustment system of an exposure apparatus according to an embodiment of the present invention;

FIG. 4A and FIG. 4B are views explaining control of an amount of exposure of an embodiment of the present invention;

FIG. 5 is a flow chart of principal parts of control of an amount of exposure of an embodiment of the present invention;

FIG. 6A to FIG. 6D are views for explaining shift focusing of an embodiment of the present invention; and

FIG. 7 is a flow chart of principal parts of shift focusing of an embodiment of the present invention.

### DESCRIPTION OF THE PREFERRED EMBODIMENTS

Next, a detailed explanation will be made of an exposure apparatus according to an embodiment of the present invention with reference to the drawings.

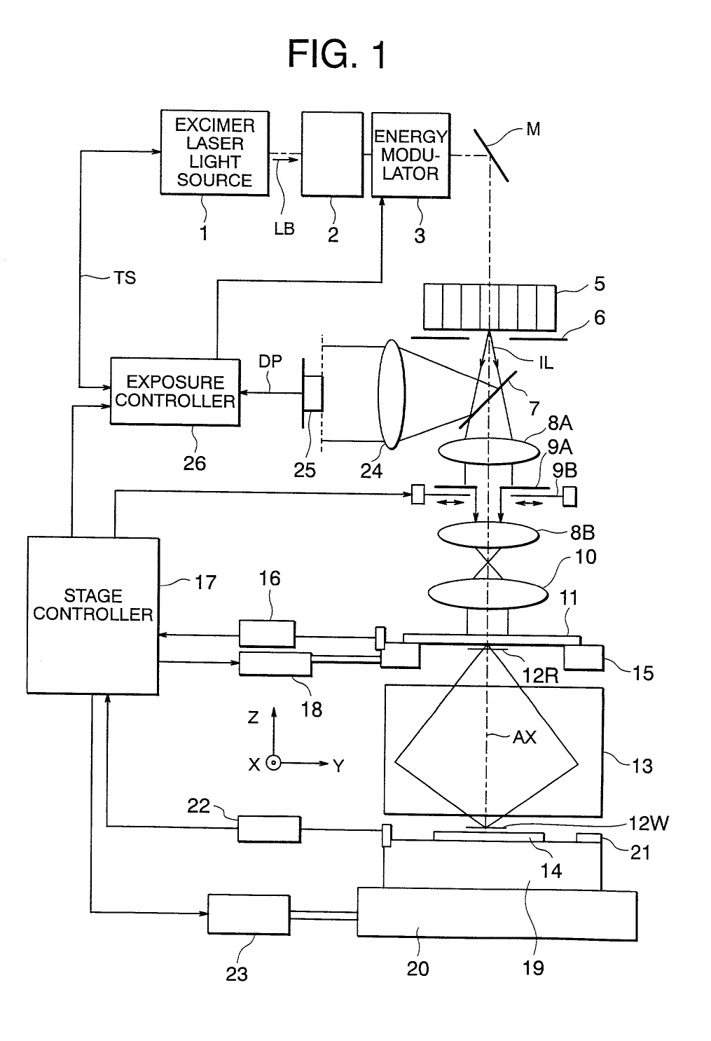

FIG. 1 shows the general configuration of a projection exposure apparatus of the present embodiment. This exposure apparatus is a step-and-repeat type reduction projection exposure apparatus using an excimer laser light source 1 emitting pulse light as the exposure light source. The laser beam LB emitted in pulses from the excimer laser light source 1 is shaped in sectional form so that it efficiently strikes a later optical integrator (rod integrator or fly-eye lens etc., in the figure, a fly-eye lens) by a beam shaping optical system 2 comprised of a cylinder lens and beam expander etc.

As the excimer laser light source 1, a KrF excimer laser light source (oscillation wavelength 248 nm) or ArF excimer laser light source (oscillation wavelength 193 nm) etc. is used. The laser beam LB emitted from the beam shaping optical system 2 enters an energy modulator 3. The energy modulator 3 is comprised of a plurality of ND filters with different transmittances (=1−light attenuation rate) arranged on a rotatable revolver. By rotating the revolver, it is possible to switch the transmittance with respect to the incident laser beam LB in several steps from 100%. Note that it is also possible to arrange two revolvers similar to the revolver and use a combination of two ND filters to finely adjust the transmittance.

The laser beam LB emitted from the energy modulator 3 enters the fly-eye lens 5 through a mirror M for bending the optical path. The fly-eye lens 5 forms a plurality of secondary light sources for illuminating the following reticle 11 by a uniform illumination distribution. Fly-eye lens 5 may also be directly arranged in series to improve the uniformity of the illumination distribution. An aperture stop (so-called a-stop) 6 is arranged at the emission face of the fly-eye lens 5. The laser beam emitted from the secondary light source in the aperture stop 6 (hereinafter called the “pulse illumination light IL”) enters a beam splitter 7 with a small reflectance and a large transmittance. The pulse illumination light IL used as the exposure light passing through the beam splitter 7 passes through a first relay lens 8A and through a rectangular aperture of a reticle blind mechanism having a plurality of blinds 9A and 9B.

The blinds 9A and 9B are arranged near the conjugate face of the pattern surface of the reticle. Further, the blinds 9A and 9B can move in a retracting direction from the optical path of the pulse illumination light IL to change the area of the reticle 11 illuminated by the pulse illumination light IL.

The pulse illumination light IL passing through the reticle blind mechanism illuminates a reticular illumination area 12R on the reticle 11 held on a reticle stage 15 by a uniform illumination distribution through a second relay lens 8B and condenser lens 10. An image of the pattern in the illumination area 12R on the reticle 11 reduced by a projection magnification α (α is for example ¼, ⅕, etc.) through a projection optical system 13 is projected and exposed on the exposure area (shot area) 12W on a wafer 14 coated with a photoresist. Below, the explanation will be given designating the direction parallel to the optical axis AX of the projection optical system 13 as the Z-direction, the direction vertical to the paper surface of FIG. 1 in the plane vertical to the optical axis AX as the X-direction, and the direction vertical to the X-direction as the Y-direction (direction parallel to paper surface of FIG. 1).

The posture of the reticle 11 is detected by a moving mirror fixed on the reticle stage 15 and an external laser interferometer 16 and is finely adjusted by a reticle stage drive 18 based on commands of a stage controller 17.

On the other hand, the wafer 14 is placed on a Z-stage 19 through a not shown wafer holder, while the Z-stage 19 is placed on an XY stage 20. The XY stage 20 positions the wafer 14 in the X-direction and Y-direction.

Further, the Z-stage 19 has the function of adjusting the position of the wafer 14 in the Z-direction and adjusting the tilt angle of the wafer 14 with respect to the XY plane. The X-coordinate and Y-coordinate of the XY stage 20 measured by the moving mirror fixed on the Z-stage 19 and the external laser interferometer 22 are supplied to the stage controller 17. The stage controller 17 controls the positioning of the XY stage 20 via the wafer stage drive 23 based on the coordinates supplied.

The operation of the stage controller 17 is controlled by a not shown main control system MC controlling the apparatus as a whole. An illumination uniformity sensor 21 comprised of a photoelectric conversion element is provided near the wafer 14 on the Z-stage 19. The receiving surface of the illumination uniformity sensor 21 is set at a height the same as the surface of the wafer 14. As the illumination uniformity sensor 21, use may be made of a PIN type photodiode having a sensitivity in the far ultraviolet and having a high response frequency for detecting the pulse illumination light. The detection signal of the illumination uniformity sensor 21 is supplied through a not shown peak hold circuit and analog/digital (A/D) converter to the exposure controller 26.

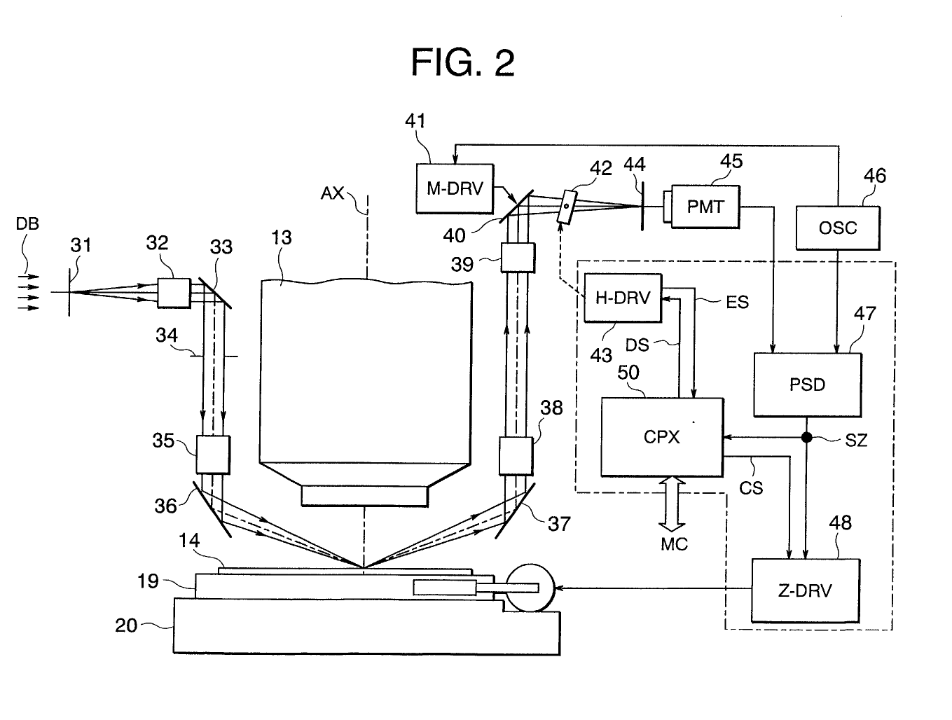

Here, an explanation will be made of a focus detection system (focus adjustment system) with reference to FIG. 2. A broadband detection beam DB having a band in the red or infrared band illuminates the slit 31. The detection beam DB emitted from the slit 31 is projected obliquely through the lens system 32, mirror 33, aperture stop 34, object lens 35, and mirror 36 to the surface of the wafer 14. An image of the slit 31 is formed on the wafer 14 at this time. The reflected beam DB of the slit image passes through the mirror 37, object lens 38, lens system 39, vibrating mirror 40, variable angle parallel sheet glass (hereinafter referred to as the “plane parallel”) 42 and is refocused on the detection slit 44.

A photo multiplier 45 photoelectrically detects the luminous flux of the slit image passing through the slit 44 and outputs the photoelectric signal to the synchronous detection circuit (PSD) 47. A vibrating mirror 40 is made to vibrate in a predetermined angular range in response to a sinusoidal signal of a predetermined frequency from an oscillator (OSC) 46 through a mirror drive circuit (MDRV) 41. The image of the slit 31 refocused on the detection slit 44 vibrates finely in a direction orthogonal to the longitudinal direction of the slit. The photoelectric signal of the photo multiplier 45 is modulated in accordance with the frequency of the oscillator 46. The synchronous detection circuit 47 detects the phase of the photoelectric signal from the photo multiplier 45 using as a reference a raw signal from the oscillator 46 and outputs a detection signal SZ to a processing circuit (CPX) 50 and a Z-drive circuit (Z-DRV) 48 of the Z-stage 19. Further, the slit 31 and the detection slit 44 are not limited to one slit and may also be a plurality of slits (multipoint focus detection system).

The detection signal SZ is set so as to become the zero level when the surface of the wafer 14 becomes in register with the best focus (BF) of the projection optical system 13. An analog signal which becomes a positive level when the wafer 14 deviates upward along the optical axis AX from this state and so as to become a negative level when it deviates in the reverse direction is output. The Z-drive circuit 48 can drive the Z-stage 19 in accordance with a control signal CS from the processing circuit 50 so that the detection signal SZ becomes the zero level, whereby autofocusing of the wafer 14 becomes possible. Note that in step-wise cumulative focusing, the Zstage 19 is driven in steps so that the detection signal SZ becomes a level offset in accordance with the plurality of Z-positions of the positioning of the wafer 14.

The processing circuit 50 outputs a drive signal DS to a drive (H-DRV) 43 for adjusting the tilt of the plane parallel 42 to the optical axis. The drive 43 includes a drive motor and an encoder for monitoring the amount of tilt of the plane parallel 42. An up-down pulse output ES from the encoder is supplied to the processing circuit 50. By changing the tilt of the plane parallel 42 to the optical axis, it is possible to change the reference position (detection center) where the output of the synchronous detection circuit 47 becomes the zero level. Normally, when the tilt of the plane parallel 42 to the optical axis is in register with the best focus (BF) of the projection optical system 13, the angle where the detection signal SZ output from the synchronous detection circuit 47 becomes the zero level (found in advance or by need) is set.

The processing circuit 50 ends such a command signal CS (disabled focus lock signal) to the Z-drive circuit 48 at the time of autofocusing under the control of a not shown main control system MC so that the Z-drive circuit 48 controls the stage 19 by feedback so that the detection signal SZ from the synchronous detection circuit 47 becomes the zero level. This autofocusing is performed at the exposure position when not performing cumulative focusing or at the shift position when performing shift focusing.

When performing shift focusing, when the autofocusing servo settles down and the level of the signal SZ is read by the processing circuit 50 and becomes the zero level, a command signal CS (enabled focus lock signal) is sent from the processing circuit 50 to the Z-drive circuit 48 and the drive of the Z-stage 19 is prohibited.

Refer to FIG. 1 again. The pulse illumination light IL reflected at the beam splitter 7 is received at an integrator sensor 25 comprised of the photoelectric conversion element through a condensing lens 24. The photoelectric conversion signal of the integrator sensor 25 is supplied through a not shown peak hold circuit and A/D converter as an output DP (digit/pulse) to the exposure controller 26. The correlation function between the output DP of the integrator sensor 25 and the illumination (amount of exposure) of the pulse illumination light IL on the surface of the wafer 14 is found in advance and stored in the exposure controller 26. The exposure controller 26 controls the emission timing and emission power etc. of the excimer laser light source 1 by supplying control information TS to the excimer laser light source 1. The exposure controller 26 controls the energy modulator 3.

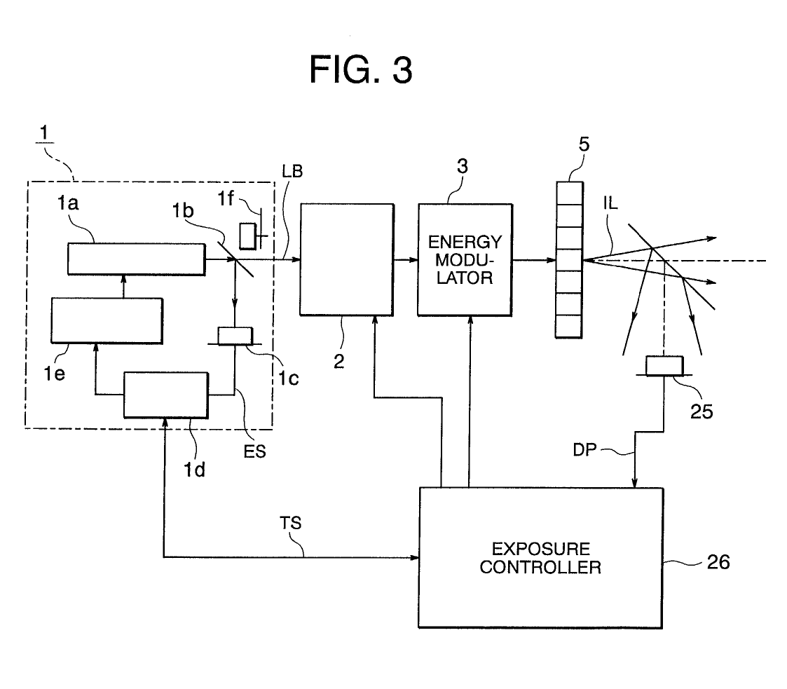

Next, details of the light source 1 of the exposure apparatus and the configuration of an energy control system will be explained with reference to FIG. 3. Inside the excimer laser light source 1, the laser beam emitted in pulses from the laser oscillator 1a enters the beam splitter 1b having a high transmittance and a slight reflectance. The laser beam LB passing through the beam splitter 1b is emitted to the outside. Further, the laser beam reflected at the beam splitter 1b enters an energy monitor 1c comprised of a photoelectric conversion element. The photoelectric conversion signal from the energy monitor 1c is supplied through a not shown peak hold circuit as the output ES to the energy controller 1d.

The unit of the amount of control of the energy corresponding to the output ES of the energy monitor 1c is (mJ/pulse). At the time of normal emission, the energy controller 1d controls the voltage of the power source at the high voltage power source 1e so that the output ES of the energy monitor 1c becomes a value corresponding to the target value of the energy per pulse in the control information TS supplied from the exposure controller 26. The energy per pulse at the laser oscillator 1a is determined in accordance with the power source voltage. Due to this, the energy per pulse at the excimer laser light source 1 becomes a value instructed by the exposure controller 26.

The energy per pulse of the excimer laser light source 1 usually is stabilized at a predetermined center energy E0, but can be changed in a predetermined range above and below the center energy E0. Further, a shutter if for blocking the laser beam LB in accordance with control information from the exposure controller 26 is arranged at the outside of the beam splitter 1b inside the excimer laser light source 1.

Further, the output ES of the energy monitor 1c is supplied through the energy controller id to the exposure controller 26. At the exposure controller 26, the correlation between the output ES of the energy controller 1c and the output DP of the integrator sensor 25 is found. At the time of exposure, the exposure controller 26 sends predetermined control information TS to the energy controller 1c, causes the excimer laser light source 1 to emit pulse light, and cumulatively adds the output DP from the integrator sensor 25 for each pulse illumination light to find the cumulative amount of exposure on the wafer 14. Further, the exposure controller 26 adjusts the transmittance at the energy modulator 3 and finely adjusts the energy per pulse at the excimer laser light source 1 so that the cumulative amount of exposure becomes the set amount of exposure for the photoresist on the wafer 14.

[Control of Amount of Exposure]

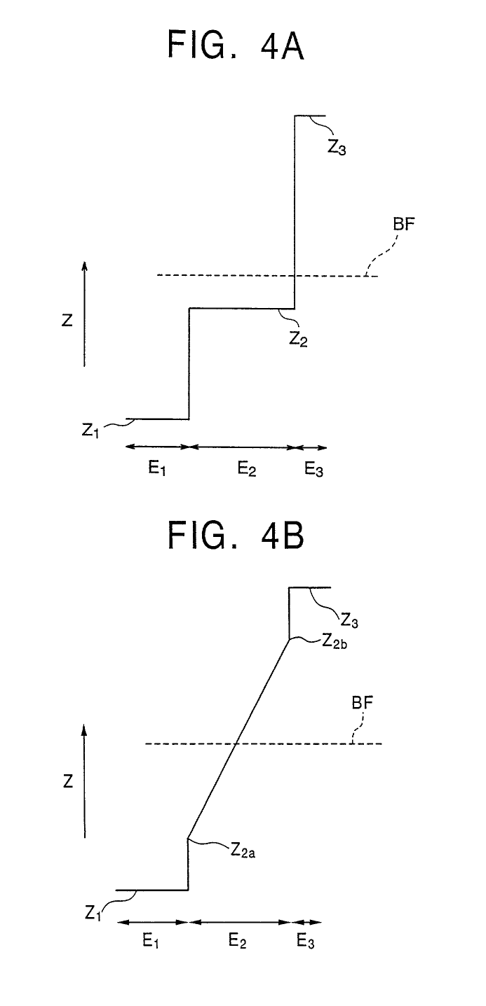

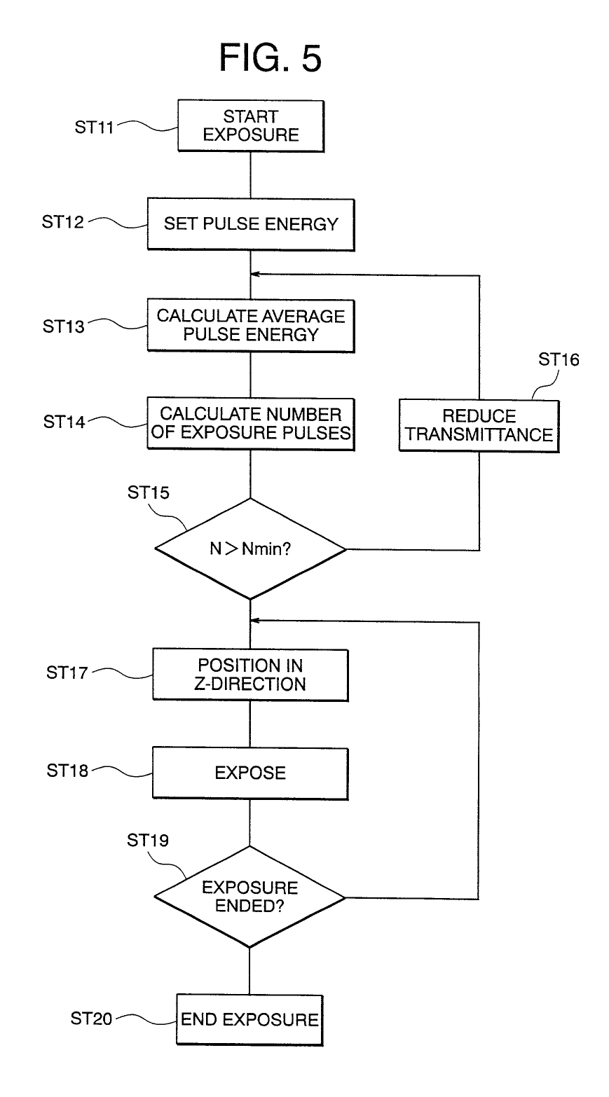

The operation for control of the amount of exposure when employing step-wise cumulative focusing for intermittently exposing a shot a plurality of times while step-wise positioning a shot to be exposed of the wafer 14 at a plurality of positions (Z-positions) in a range including the best focus of the Z-direction in the projection exposure apparatus of the present embodiment will be explained with reference to FIG. 4A and FIG. 5.

Here, as shown in FIG. 4A, it is assumed that exposure is performed using step-wise cumulative focusing giving target amounts of exposure of E1, E2, and E3 (here, E2>E1>E3) at three locations in the Z-direction (Z1, Z2, Z3) and that the necessary parameters are input in advance into a storage device provided in the main control system MC. “BF” in FIG. 4A shows the best focus of the projection optical system 13. These are simple examples. The number of positions in the Z-direction, the target amounts of exposure at the Z-positions, and the relation between the best focus BF and the Z-positions are not limited to these settings.

In FIG. 5, when the exposure is started (ST11), first, the Z-position set with the maximum amount of exposure (maximum exposure position) in the Z-positions is found and the energy per pulse of the laser beam LB is set in accordance with the target amount of exposure at the maximum exposure position (ST12). Here, since the amount of exposure is greatest at the position Z2, the energy per pulse is set based on the target amount of exposure E2.

Next, the excimer laser light source 1 is made to emit pulses experimentally a plurality of times (for example, 100 times) and the output of the integrator sensor 25 is cumulatively added so as to measure the average pulse energy density p(mJ/(cm²·pulse)) on the wafer indirectly (ST13). Next, the number of exposure pulses N2 at the maximum exposure position Z2 is calculated in accordance with N=cint(E/p) (ST14). Here, N is the number of pulses, E is the amount of exposure, and cint is a function for rounding off the value of the first decimal place after the decimal point.

Next, it is judged if the number of exposure pulses N is equal to or greater than the minimum number of pulses Nmin for obtaining the necessary accuracy of reproduction of control of the amount of exposure (ST15). The minimum number of exposure pulses Nmin is the minimum number of pulses able to be ignored relative to the target exposure accuracy obtained by averaging the variations in energy of the pulses of the laser beam LB. That is, the cumulative amount of exposure when emitting a number of pulses of at least Nmin is a number deemed substantially the same relative to the exposure accuracy no matter the number of repetitions (giving the required accuracy of reproduction of the amount of exposure). The minimum number of exposure pulses Nmin can be determined logically based on the design specifications of the excimer laser light source 1 or can be found experimentally based on the output of the sensor 1c or 25 by making the excimer laser light source 1 emit pulse light a plurality of times.

When it is judged at ST15 that the number of exposure pulses N is equal to the minimum number of exposure pulses Nmin or smaller than the minimum number of exposure pulses Nmin, the setting of the energy modulator 3 is changed, the transmittance is lowered (ST16), that is, a transmittance whereby the number of exposure pulses N becomes larger than the minimum number of exposure pulses Nmin is selected and set from among transmittances obtained by combining the ND filters of the energy modulator 3, then the routine returns to ST13.

When it is judged at ST15 that the number of exposure pulses N is larger than the minimum number of exposure pulses Nmin, the surface of the wafer 14 is positioned so as to become in register with one of the Z-positions (ST17). That is, the Z-stage 19 is feedback controlled so that the detection signal SZ of the focus detection system shown in FIG. 2 becomes a level offset from the zero level in accordance with a value corresponding to the distance between the best focus BF and Z-position.

When the surface of the wafer 14 is positioned at the Z-position, the laser beam LB starts to be emitted (the shutter 1f is opened) and stops (the shutter if is closed) after the elapse of a time corresponding to the number of pulses N (N=E/p) so that the amount of exposure at the Z-position becomes the target amount of exposure E at the Z-position (ST18). Next, it is judged if the exposure has been ended for all Z-positions (ST19). When it is judged that it is not ended, the routine returns to ST17 where exposure is similarly repeated for the remaining (unprocessed) Z-positions, while when it is judged that it has ended, the exposure for one shot is ended (ST20).

More specifically, while not limited to this, here, it is assumed that the exposure is performed in the order of the lowest Z-positions up (Z1, Z2, and Z3) and the Z-stage 19 is controlled in drive so that the surface of the wafer 14 is positioned at the position Z1 and the laser beam LB is emitted for exactly a time corresponding to the number of pulses N1 (N1=E1/p) so that the amount of exposure at the position Z1 becomes the target amount of exposure E1.

Next, similarly the Z-stage 19 is controlled in drive so that the surface of the wafer 14 is positioned at the position Z2 and the laser beam LB is emitted for exactly a time corresponding to the number of pulses N2 (N2=E2/p) so that the amount of exposure at the position Z2 becomes the target amount of exposure E2. Note that the number of pulses N2 is at least the minimum number of pulses Nmin as explained above.

Similarly, the Z-stage 19 is controlled in drive so that the surface of the wafer 14 is positioned at the position Z3 and the laser beam LB is emitted for exactly a time corresponding to the number of pulses N3 (N3=E3/p) so that the amount of exposure at the position Z3 becomes the target amount of exposure E3. Since the position Z3 becomes the final exposure of the shot, it is preferable to end the exposure at the time when the total cumulative amount of exposure for the shot becomes (E1+E2+E3) based on the detection value of the integrator sensor 25.

Note that once the exposure of one shot ends, similar exposure is repeated while moving the wafer 14 successively in the XY direction in accordance with the shot array. Further, in the example of the control process of the amount of exposure described above, the method of step-wise cumulative focusing is used. The present invention may not be limited to this but may be exposure processing using the method of continuous cumulative focusing. Specifically, as shown in FIG. 4B, the target amounts of exposure are set to E1 and E3 in two positions along the z-direction, respectively, and set to E2 in a position region Z2a to Z2b. At this time, a number of pulses in the position region Z2a to Z2b is set up so that it becomes more than the minimum number of pulses Nmin in the same way as mentioned above. Further, it is preferable that moving velocity of the wafer 14 is constant in the position region between Z2a and Z2b. The moving velocity is determined based on the target exposure amount E2, the average density P of pulse energy and the frequency of the light from the light source. Further, each positions of Z1, Z3, Z2a, Z2b can be changed according to the pattern by which the exposure processing is carried out. Furthermore, the positions of Z1, Z3 may have an optional position region as not overlapping with the position region Z2a to Z2b.

[Shift Focusing]

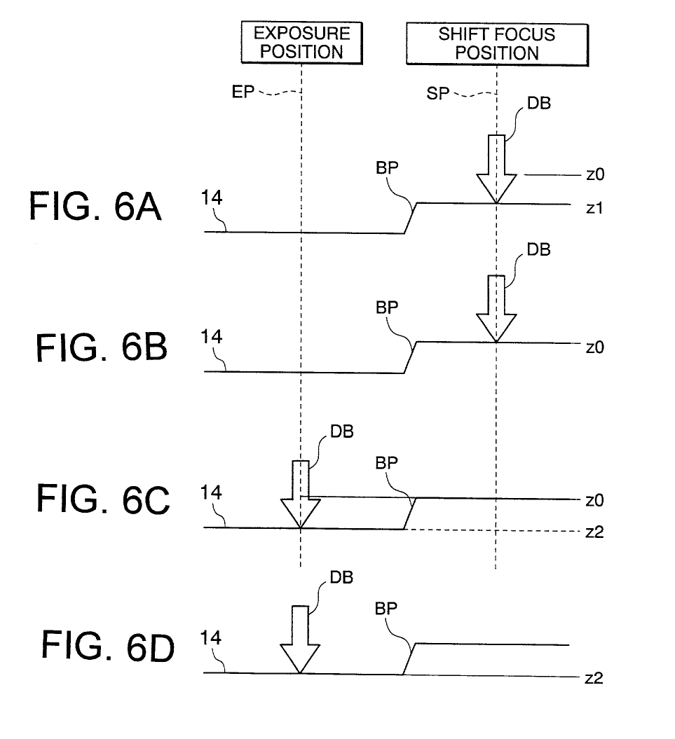

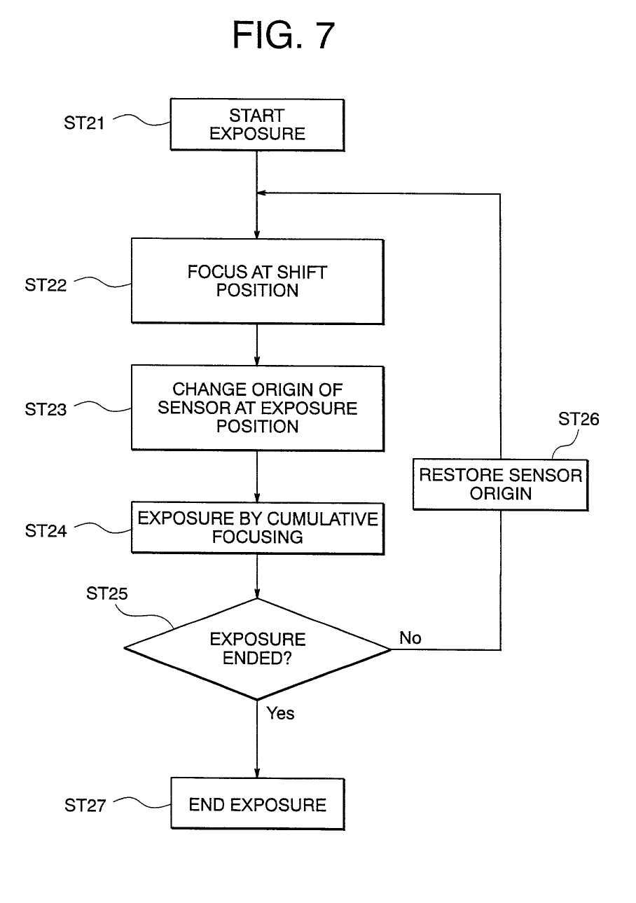

Below, shift focusing in the projection exposure apparatus of the present embodiment will be explained with reference to FIG. 6A to FIG. 6D and FIG. 7.

In the state where the projection position of the pattern and the detection position of the focus substantially become in register and the shot to be exposed (exposure position) on the wafer 14 set at the projection position, usually focusing, that is, detection of the position of the surface of the wafer 14 in the Z-direction and the positioning of the surface of the wafer 14 by the Z-stage in the Z-direction, is performed. This is the assumption in the above explanation as well. Due to the above explained situation, sometimes the exposure position is set to the projection position and exposure performed after setting the projection position (detection position) to a shift position SP different from the exposure position.

In such a case, when there is a step in the Z-direction between the exposure position and the shift position and using continuous cumulative focusing for exposure while continuously moving the position of the wafer in the Z-direction or the above step-wise cumulative focusing, the focus detection system has to have an effective detection range corresponding to the amount of the maximum amount of distance of the Z-position furthest away from the best focus plus the amount of the step difference. Increasing the effective detection range, however, has great disadvantages in terms of detection accuracy and cost. When a sufficient effective detection range cannot be secured, it is necessary to sacrifice the detection accuracy or forget about employing cumulative focusing.

Therefore, in this embodiment, this inconvenience is improved by the following processing. Note that in FIG. 6A to FIG. 6D, the white arrows shown by reference DB show the detection beams for detection of the focus. Further, as shown in FIG. 6A to FIG. 6D, assume that there is a step (BP) having a certain height in the Z-direction between the exposure position EP (shot) of the wafer 14 and the shift position SP (shift focus position) shifted by exactly a predetermined amount from the exposure position EP. Further, in the case of a multipoint focus detection system emitting a plurality of detection beams, it is preferable to perform shift focusing using a detection beam closest to the shift position in the shot (not focused position).

When the exposure is started (ST21), first, the XY stage 20 is driven to move the wafer 14 so that the shift position SP of the wafer 14 becomes in register with the focus detection position of the focus detection system (assumed to be equal to the projection position (projection center) of the projection optical system 13). In this state, as shown in FIG. 6A, the surface of the wafer 14 at the shift position SP usually is not in register with the origin z0 of the reference position of the focus detection system. Here, it is assumed to be at z1 lower than the origin z0.

Automatic focusing is performed at this shift position SP (ST22). Specifically, in the focus detection system of FIG. 2, the Z-stage 19 is driven by the Z-drive circuit 48 so that the detection signal SR becomes the zero level. In other words, the stage is driven (in this case, raised) so that the position of the surface in the Z-direction at the shift position SP of the wafer 14 becomes the origin z0. Note that when the automatic focusing at this position ends, a signal commanding focus lock is sent from the processing circuit 50 to the Z-drive circuit 48 to stop the driving of the Z-stage by the Z-drive circuit 48. That is, the position of the surface of the wafer 14 is fixed.

Next, the XY stage 20 is driven to drive the wafer 14 so that the exposure position EP of the wafer 14 becomes in register with the detection position of the focus detection system, that is, so the exposure position EP becomes in register with the projection position. This state is shown in FIG. 6C. Since there is a step BM between the exposure position EP and shift position SP of the wafer 14, the surface of the wafer 14 at the exposure position EP is positioned at z2 lower by exactly an amount corresponding to the step BM.

Next, that the origin of the focus detection system is changed at the exposure position EP (ST23). Specifically, the tilt of the plane parallel 42 with respect to the optical axis is changed by the drive 43 so that the detection signal SR becomes the zero level at the focus detection system of FIG. 2. In other words, the origin of the focus detection system is set to z2. This state is shown in FIG. 6D.

Next, exposure is performed by continuous cumulative focusing or step-wise cumulative focusing method, whereby the exposure of one shot (ST24). Next, it is judged if the exposure has ended for all shots (ST25). When it is judged that it has not ended, the routine proceeds to step ST26, where the origin of the focus detection system is returned to its original state (the tilt of the plane parallel 42 of FIG. 2 to the optical axis is returned to the angle before the change at ST23 and the origin is set to z0). The routine then returns to ST22, where exposure is repeated in the same way for the remaining (unprocessed) shots. When it is judged that it has ended at ST25, the exposure of the wafer 14 ends (ST27).

Note that the embodiment explained above was described to facilitate the understanding of the present invention. It was not described to limit the present invention. Therefore, elements disclosed in the above embodiment include all design changes or equivalents belonging to the technical scope of the present invention.

For example, in the above embodiment, to make the cumulative number of pulses of the exposure pulse light IL at the Z-position giving the maximum amount of exposure in exposure by step-wise cumulative focusing at least the minimum number of exposure pulses, light is attenuated by the energy modulator 3, but the light may also be attenuated by changing the energy setting of the excimer laser light source 1 or combining these. Further, the focus detection system is not limited to that shown in FIG. 2. It is also possible to use a system providing a CCD or other pickup element as a sensor.

In the above embodiment, as the light source for exposure, use was made of a KrF excimer laser of a wavelength of 248 nm or an ArF excimer laser light of a wavelength of 193 nm, but it is also possible to use for example an F₂ laser (wavelength 157 nm), Ar₂ laser (wavelength 126 nm), or other pulse light emitting light source.

In an exposure apparatus using an F₂ laser as a light source, for example the refraction optical members used for the illumination optical system or the projection optical system (lens elements) are all made of fluorite, the air in the laser light source, illumination optical system, and projection optical system is for example replaced by helium gas, and the space between the illumination optical system and projection optical system and the space between the projection optical system and the substrate are filled with helium gas. Further, as the reticle, use is made of one produced from fluorite, fluorine-doped silica glass, magnesium fluoride, LiF, LaF₃, and lithium-calcium-aluminum fluoride (LiCaAlF crystal), or rock crystal.

Note that, instead of an excimer laser, it is also possible to use a harmonic of a YAG laser or other solid laser having an oscillation spectrum at any of a wavelength of 248 nm, 193 nm, and 157 nm.

Further, it is possible to use an infrared region or visible region single wavelength laser light emitted from a DFB semiconductor laser or fiber laser amplified by for example an erbium (or both erbium and yttrium) doped fiber amplifier and use the harmonic obtained by converting the wavelength to ultraviolet light using a nonlinear optical crystal.

For example, if the oscillation wavelength of the single wavelength laser is made a range of 1.51 to 1.59 μm, an 8th harmonic of an oscillation wavelength in the range of 189 to 199 nm or a 10th harmonic of an oscillation wavelength in the range of 151 to 159 nm is output. In particular, if the oscillation wavelength is made one in the range of 1.544 to 1.553 μm, ultraviolet light of an 8th harmonic in the range of 193 to 194 nm, that is, a wavelength substantially the same as that of an ArF excimer laser, is obtained. If the oscillation wavelength is made one in the range of 1.57 to 1.58 μm, ultraviolet light of a 10th harmonic in the range of 157 to 158 nm, that is, a wavelength substantially the same as that of an F₂ laser, is obtained.

Further, if the oscillation wavelength is made one in the range of 1.03 to 1.12 μm, a 7th harmonic of an oscillation wavelength in the range of 147 to 160 nm is output. In particular, if the oscillation wavelength is made one in the range of 1.099 to 1.106 μm, ultraviolet light of a 7th harmonic in the range of 157 to 158 nm, that is, a wavelength substantially the same as that of an F₂ laser, is obtained. Note that as the single wavelength oscillation laser, a yttrium-doped fiber laser is used.

The projection optical system is not limited to a reduction system and may also be an equal magnification system or an enlargement system (for example, an exposure apparatus for producing a liquid crystal display or plasma display). Further, the projection optical system may be any of a catoptric system, a dioptric system, and a catadioptric system.

Further, the present invention may be applied to not only an exposure apparatus used for the production of a thin-film magnetic head, but also an exposure apparatus transferring a device pattern on a glass plate used for the production of displays including a liquid crystal display, an exposure apparatus transferring a device pattern on a ceramic wafer used for production of a semiconductor device, an exposure apparatus used for production of an image pickup device (CCD), micromachine, DNA chip, an exposure apparatus used for the production of a photomask, etc.

The exposure apparatus of the present embodiment may be produced by assembling an illumination optical system comprised of a plurality of lenses and a projection optical system into the body of the exposure apparatus and optically adjusting them, attaching the reticle stage or substrate stage comprised of the large number of mechanical parts to the exposure apparatus body and connecting the wiring and piping, and further performing overall adjustment (electrical adjustment, confirmation of operation, etc.) Note that the exposure apparatus is desirably manufactured in a clean room controlled in temperature and cleanness etc.

The semiconductor device is produced through a step of design of the functions and performance of the device, a step of production of a reticle based on the design step, a step of production of a wafer from a silicon material, a step of exposing and transferring a pattern of the master on to a wafer using a lithography system including an exposure apparatus of the present embodiment etc., a step of assembly of the device (including dicing, bonding, packaging, etc.), and an inspection step.

As explained above, according to the present invention, there is the effect that it is possible to realize sufficient reproducibility of accuracy of control of the amount of exposure at the time of stepwise cumulative focusing using pulse light as the exposure light, so it becomes possible to form a pattern with a good accuracy including patterns with a large aspect ratio.

Further, when employing shift focusing and cumulative focusing, there is the effect that it is possible to prevent the occurrence of error in the detection of the focus or inability of detection without using a focus detection device having a broad effective detection range.

The present disclosure relates to subject matter contained in Japanese Patent Application No. 2000-161427, filed on May 31, 2000, the disclosure of which is expressly incorporated herein by reference in its entirety.

1. An exposure method for exposing an identical location of a substrate being exposed a plurality of times through a mask formed with a pattern while giving different amounts of exposure to the substrate by pulse light at a plurality of positions or position regions in the direction in which the substrate is irradiated by the pulse light, comprising a step of setting an energy of the pulse light so that the cumulative number of pulses of the pulse light at the position or position region giving the maximum amount of exposure among the plurality of positions becomes at least a predetermined number of pulses.

2. An exposure method as set forth in claim 1, wherein the predetermined number of pulses is set to a number of an extent able to be ignored relative to a targeted exposure accuracy obtained by averaging the variations in energy of the pulses of the pulse light.

3. An exposure apparatus comprising:
an adjustment device which adjusts an energy of pulse light irradiating a mask formed with a pattern;
a projection optical system which projects an image of the pattern of the mask on a substrate;
a stage which moves the substrate in an optical axis direction along the optical axis of the projection optical system; and
a control device which controls for exposing an identical location of said substrate a plurality of times while moving the stage in said optical axis direction and changing the amount of exposure by the pulse light in accordance with the position or position region of the stage, and controls the adjusting device so that a cumulative number of pulses of said pulse light at the position or position region giving the maximum amount of exposure among the plurality of positions of the stage becomes at least a predetermined number.

4. An exposur method comprising:
a first movement step of moving a substrate being exposed so that its position in an optical axis direction along a projection optical axis becomes in register with a reference position based on a detection value detected by a focus detection device having an effective detection area of a predetermined range in said optical axis direction at a shift position shifted in a plane orthogonal to the projection optical axis from an exposure position to be exposed through a mask formed with a pattern on said substrate;
a second movement step of moving said substrate in said plane orthogonal to the optical axis so that the exposure position becomes in register with a projection position of an image of a pattern of the mask;
a changing step of changing said reference position so that the reference position becomes in register with the position of the substrate in the optical axis direction based on the detection value detected by the focus detection device at the exposure position; and
an exposure step of exposing the same location of the substrate through the mask while moving the substrate in the optical axis direction in accordance with the detection value of the focus detection device.

5. An exposure method as set forth in claim 4, further comprising, in said exposure step, performing exposure while moving the substrate continuously in the optical axis direction.

6. An exposure method as set forth in claim 4, further comprising, in said exposure step, performing exposure a plurality of times intermittently while moving the substrate in steps in the optical axis direction.

7. An exposure apparatus comprising:
a projection optical system which projects an image of a pattern of a mask irradiated by exposure light on a substrate;
a stage which moves said substrate in an optical axis direction along an optical axis of said projection optical system and in a plane orthogonal to the optical axis substantially orthogonal to the optical axis direction;
a focus detection device having an effective detection area of a predetermined range in said optical axis direction and detecting a position of said substrate in said optical axis direction at a projection position of said projection optical system; and
a control device which controls the stage to move the substrate so that its position in the optical axis direction becomes in register with a reference position based on a detection value detected by said focus detection device in a state setting a shift position shifted in said plane orthogonal to the optical axis from the exposure position to be exposed through said mask on said substrate at said projection position, changes the reference position so that the reference position becomes in register with the position of the substrate in the optical axis direction based on the detection value detected by the focus detection device in the state setting the exposure position to the projection position, and exposes the same location of the substrate through the mask while moving the substrate in the optical axis direction in accordance with the detection value of the focus detection device.

8. An exposure apparatus as set forth in claim 7, wherein said control device performs control so as to exposure while moving the substrate continuously in the optical axis direction.

9. An exposure apparatus as set forth in claim 7, wherein said control device performs exposure a plurality of times intermittently while moving the substrate in steps in the optical axis direction.

10. An exposure apparatus as set forth in claim 7, wherein said focus detection device comprises a sensor for detecting a position of said substrate in said optical axis direction by detecting a shift, from said reference position, of an imaging position of detection beam irradiated on said substrate and reflected at said substrate and a reference position adjusting device provided on an optical path of said detection beam for adjusting an imaging position of said detection beam on said sensor.

11. A process of production of a device comprising a step of exposing a substrate using an exposure method as set forth in claim 1.

12. A process of production of a device comprising a step of exposing a substrate using an exposure method as set forth in claim 4.

13. A process of production of a device comprising a step of exposing a substrate using an exposure apparatus as set forth in claim 3.

14. A process of production of a device comprising a step of exposing a substrate using an exposure apparatus as set forth in claim 7.
